(19) United States
(12) Patent Application Publication
(10) Pub. No.: US 2010/0181214 A1
(43) Pub. Date: Jul. 22, 2010

(54) Apparatus For Storing Dentures

(76) Inventor: Vicki Brown, Washington, DC (US)

Correspondence Address: L.C. Begin & Associates, PLLC, 510 Highland Avenue, PMB 403, Milford, MI, 48381, US

(21) Appl. No.: 12/691,342

(22) Filed: Jan. 21, 2010

Related U.S. Application Data
(60) Provisional application No. 61/146,338, filed on Jan. 22, 2009.

(51) Int. Cl. A61C 19/02; B65D 1/34

(52) U.S. Cl. 206/63.5; 206/557

(57) ABSTRACT

One embodiment of an apparatus for storing dentures may include a receptacle having a base and a wall extending vertically upwardly from a periphery of the base to define an enclosure therewithin. The apparatus may further include a tray adapted to be removably received and carried within the enclosure of the receptacle. The tray may be capable of carrying the dentures thereon. Further, the apparatus may also include a cover hingedly carried by the receptacle and adapted to cover the tray received within the enclosure of the receptacle.

### CROSS REFERENCE TO RELATED APPLICATION

This application claims the benefit of U.S. Provisional Application No. 61/146,338 filed on Jan. 22, 2009 the disclosure of which is incorporated by reference.

### FIELD OF THE DISCLOSURE

The present disclosure generally relates to apparatuses for storing prosthetic articles, and more particularly, to an apparatus for storing dentures.

### BACKGROUND OF THE DISCLOSURE

Individuals, who wear dentures, may any time feel the need of removing their dentures, even when present at a public place, such as a restaurant, a hotel and the like. However, removing and then placing the dentures at any location in a public place may pose a potential problem for the individuals as the individuals may need to keep the dentures in open and/or an unhygienic area This may result in contamination of the dentures. Further, some individuals resort to use a tissue or a napkin to wrap their dentures after removing the dentures from their mouths. However, use of the tissue or the napkin may also be associated with contamination of the dentures, as the tissue or the napkin may leave some fibrous residue on the dentures when the dentures are unwrapped. Also, the dentures wrapped in the tissue or the napkin, are often thrown away when mistaken with trash. Further, many individuals who wear dentures are also conscious about other people viewing the dentures, and accordingly such individuals may find it difficult to remove the dentures from their mouths and keep the dentures at a safe place, without exposing the dentures to the others. Further, individuals may also encounter difficulty in carrying the dentures along with them, while precluding others from viewing the dentures.

### SUMMARY OF THE DISCLOSURE

One embodiment of an apparatus for storing dentures may include a receptacle having a base and a wall extending vertically upwardly from a periphery of the base to define an enclosure therewithin. Further, the apparatus may also include a tray adapted to be removably received and carried within the enclosure of the receptacle. The tray may be capable of carrying the dentures thereon. Furthermore, the apparatus may include a cover hingedly carried by the receptacle and adapted to cover the tray received within the enclosure of the receptacle.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of an apparatus for storing dentures;

FIG. 2 is a perspective view of the apparatus of FIG. 1 having a tray removed therefrom;

FIG. 3 is a perspective view of the apparatus of FIG. 1 in a closed configuration; and

FIG. 4 is a perspective view of the apparatus of FIG. 1 with dentures carried therewithin.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular apparatus for storing dentures, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the terms, “a” and “an” herein do not denote a limitation o quantity, but rather denote the presence of at least one of the referenced item.

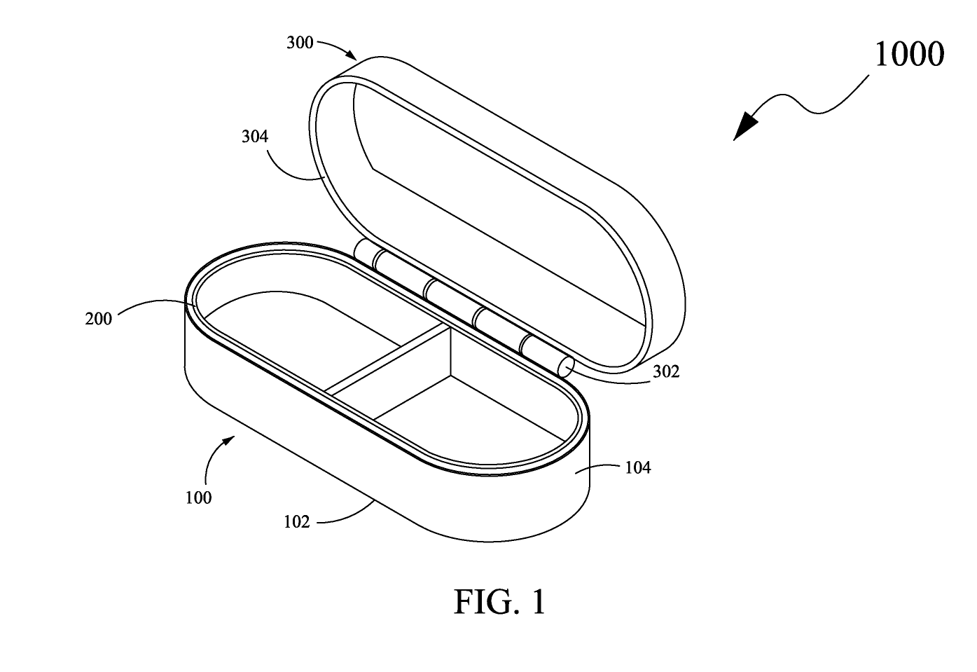

Referring to FIGS. 1-3, one embodiment of an apparatus 1000 which may be used for storing dentures, is shown.

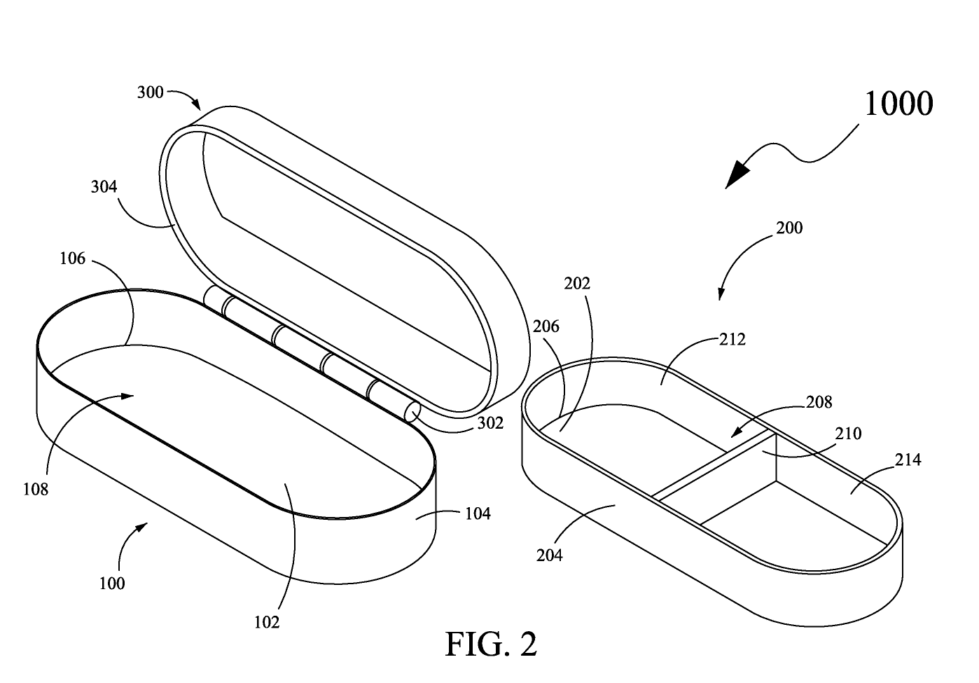

The apparatus 1000 may include a receptacle 100 having a base 102 and a wall 104 extending vertically upwardly from a periphery 106 of the base 102 to define an enclosure 108 therewithin (as shown in FIG. 2). The receptacle 100 may be configured to have an elongated oval shape. Of course, the receptacle 100 may instead be configured to have any other shape and/or size as per a manufacturer's preference. Further, the receptacle 100 may be composed of one of a hard material and a flexible material. More specifically, the receptacle 100 may be composed of a plastic material. Of course, the receptacle 100 may instead be composed of any other material without departing from the scope of the present disclosure. In addition, the receptacle 100 may be configured to have a variety of colors, such as red, blue or green, or combinations thereof, depending upon preferences of a user or the manufacturer of the apparatus 1000.

The apparatus 1000 may further include a tray 200. The tray 200 may be adapted to be removably received and carried within the enclosure 108 of the receptacle 100. The removable receiving of the tray 200 within the enclosure 108, may facilitate an easy washing and cleaning of the tray 200. The tray 200 may be capable of carrying the dentures thereon.

The tray 200 may include a floor 202, and a wall 204 extending vertically upwardly from a periphery 206 of the floor 202 for defining a cavity 208 therewithin. When the tray 200 is removably received within the enclosure 108, the floor 202 may rest on the base 102, and the wall 204 may align with the wall 104, thereby facilitating the tray 200 to be snugly received within the receptacle 100. The tray 200 may further include a partition member 210 carried by the floor 202 in order to divide the cavity 208 for forming two chambers, and more specifically, for forming a first chamber 212 and a second chamber 214. The first chamber 212 and the second chamber 214 may be adapted to carry the dentures therewithin.

The tray 200 may be composed of one of a hard material and a flexible material. More specifically, the tray 200 may be composed of a plastic material. Of course, the tray 200 may instead be composed of any other material without departing from the scope of the present disclosure. Further, the tray 200 may be configured to have an elongated oval shape. Of course, the tray 200 may instead be configured to have any other shape. The tray 200 may also be available in a variety of colors, such as a color similar to the color of the receptacle 100, or, a color complementary with the color of the receptacle 100.

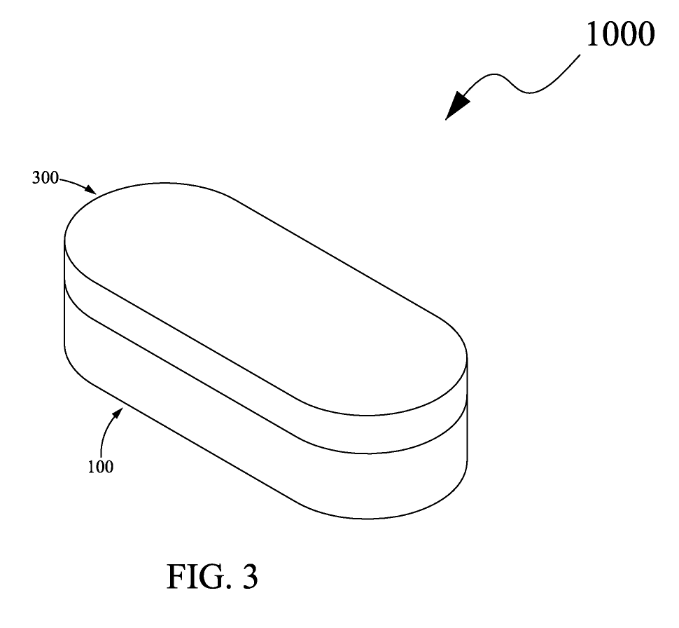

Further, the apparatus 1000 may include a cover 300. The cover 300 may be hingedly carried by the receptacle 100 through a hinge mechanism 302. Also, the cover 300 may be adapted to cover the tray 200 received within the enclosure 108 of the receptacle 100. As best shown in FIGS. 1 and 2, the cover 300 may include a peripheral edge portion 304. The peripheral edge portion 304 may be carried by the wall 104 of the receptacle 100 with the help of the hinge mechanism 302. Such a hinged association of the cover 300 with the receptacle 100 may facilitate a movement of the cover 300 from an open configuration (as shown in FIG. 1) to a closed configuration (as shown in FIG. 3). In the closed configuration, the cover 300 may be adapted to cover the enclosure 108 carrying the tray 200.

The cover 300 may be configured to have an elongated oval shape. Of course, the cover 300 may instead be configured to have any other shape and/or size as per a manufacturer's preference. The cover 300 may be composed of one of a hard material and a flexible material. More specifically, the cover 300 may be composed of a plastic material. Of course, the cover 300 may instead be manufactured from any other material without departing from the scope of the present disclosure. The cover 300 may be configured to have, a variety of colors, such as a color similar to the color of the receptacle 100 and the tray 200.

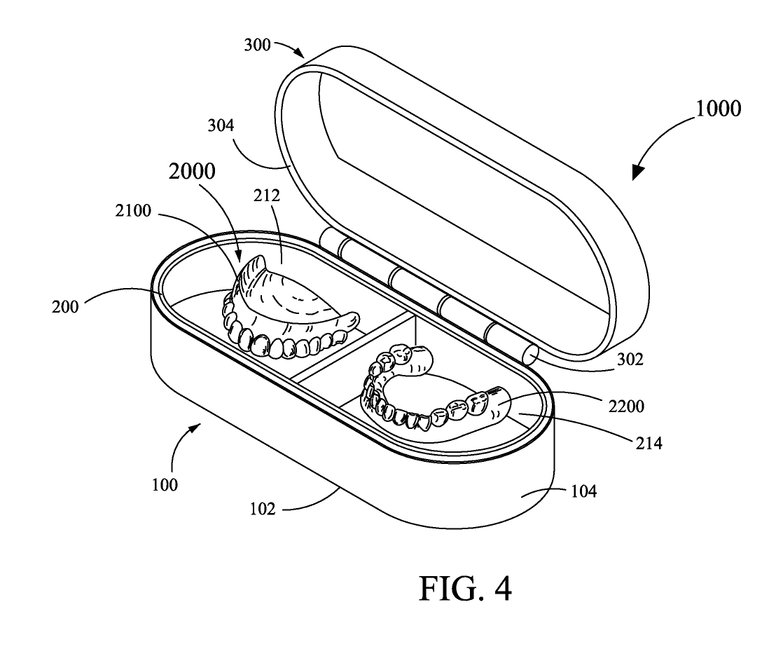

FIG. 4 is a perspective view of the apparatus 1000, with dentures 2000, carried by the tray 200. The dentures 2000 may include an upper denture 2100 and a lower denture 2200. As shown in FIG. 4, the upper denture 2100 may be carried by the first chamber 212 and the lower denture 2200 may be carried by the second chamber 214. Alternatively, the upper denture 2100 may be carried by the second chamber 214 and the lower denture 2200 may be carried by the first chamber 212.

For the purpose of the description, the apparatus 1000 is shown and described as being used for storing the dentures 2000. However, it will be evident that the apparatus 1000 may be manufactured for being utilized for storing dentures of various sizes and shapes. Further, the apparatus 1000 is shown and described to include only one tray 200. However, it should be evident that the apparatus 1000 may have more than one tray 200. Further, the apparatus 1000 may be configured to have a size suiting to a user's requirement. Specifically, the apparatus 1000 may be configured as a compact apparatus that may be easily carried along by a user.

In use, an individual, such as a denture wearer, may open the apparatus 1000, and subsequently, place the upper denture 2100 in the first chamber 212 of the tray 200 and the lower denture 2200 in the second chamber 214 of the tray 200. Thereafter, the tray 200 may be removably received in the enclosure 108 of the receptacle 100. Subsequently, the cover 300 may be closed in order to cover the tray 200 received within the enclosure 108. Upon closing the cover 300, the apparatus 1000 may be conveniently stored at any place in a restaurant, hotel, room and the like. The apparatus 1000 may also be conveniently kept in articles, such as a purse, a pocket and the like. The use of the cover 300 for covering the tray 200 may preclude the possibility of contamination of the dentures 2000. The apparatus 1000 may also be used for carrying the dentures 2000 from one place to another.

The present disclosure provides an apparatus, such as the apparatus 1000, for storing dentures. A user may feel satisfied having the apparatus along with him/her, whenever a need for removing the dentures may arise irrespective of being present at a public place. Further, the use of the apparatus may allow storing of the dentures at a safe and a hygienic place. Furthermore the use of the apparatus may preclude the user to expose his/her dentures to other individuals. In addition, the user may easily be able to carry his/her dentures stored in the apparatus along with him/her.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An apparatus for storing dentures, the apparatus comprising:
a receptacle having a base and a wall extending vertically upwardly from a periphery of the base to define an enclosure therewithin;
a tray adapted to be removably received and carried within the enclosure of the receptacle, the tray capable of carrying the dentures thereon; and
a cover hingedly carried by the receptacle and adapted to cover the tray received within the enclosure of the receptacle.

2. The apparatus of claim 1, wherein the tray comprises,
a floor; and
a wall extending vertically upwardly from a periphery of he floor for defining a cavity therewithin.

3. The apparatus of claim 2, wherein the tray further comprises a partition member carried by the floor, wherein the partition member divides the cavity for forming two chambers, each chamber of the two chambers adapted to carry a denture therewithin.

4. The apparatus of claim 1, wherein each of the receptacle and the cover is configured to have an elongated oval shape.

5. The apparatus of claim 1, wherein the receptacle is composed of a plastic material.

6. The apparatus of claim 1, wherein the cover is composed of a plastic material.

7. The apparatus of claim 1, wherein the tray is composed of one of a hard material and a flexible material.

8. The apparatus of claim 7, wherein the tray is composed of a plastic material.

9. The apparatus of claim 1, wherein the tray is configured to have an elongated oval shape.
